(19) United States
(12) Patent Application Publication
(10) Pub. No.: US 2017/0010877 A1
(43) Pub. Date: Jan. 12, 2017

(54) TIME-BASED INSTALLATION AND UNINSTALLATION OF APPLICATIONS

(71) Applicant: International Business Machines Corporation, Armonk, NY (US)

(72) Inventors: Michael Bender, Rye Brook, NY (US); David E. Nachman, Morristown, NJ (US); Michael P. Shute, Niantic, CT (US)

(21) Appl. No.: 14/793,962

(22) Filed: Jul. 8, 2015

(51) Int. Cl. G06F 9/445; H04W 88/02

(52) U.S. Cl. CPC G06F 8/62; H04W 88/02; G06F 8/61

(57) ABSTRACT

Aspects of the present invention disclose a method, computer program product, and system for managing applications on a computing device. The method includes one or more processors receiving a user utilizing a scheduling function of a computing device to schedule a time to uninstall an application from the computing device. The method further includes waiting until the scheduled time to uninstall the application. The method further includes, in response to determining that the scheduled time to uninstall the application has arrived, one or more processors uninstalling the application from the computing device. In another aspect of the present invention, the scheduling function of the computing device is a feature of operating system software of the computing device. In additional aspects of the present invention, the computing device is a mobile computing device, and the application is a mobile device application that is installed on the mobile device.

### BACKGROUND OF THE INVENTION

The present invention relates generally to the field of application management, and more particularly to time-based installation and uninstallation of applications.

A mobile application is a computer program that is designed to operate on a mobile device, such as a smartphone or table computer. Mobile applications can be made available through an application distribution platform, e.g., an application distribution platform that is hosted and operated by the owner of the mobile operating system for the mobile device. Some mobile applications are free of charge, while others may be purchased. Mobile applications are primarily downloaded from the platform to the target mobile device; however, the mobile applications can also be downloaded to laptops or desktop computers.

With the proliferation of mobile devices, the number of applications that are designed for mobile devices has increased greatly in the marketplace. In addition, mobile device users are turning to mobile applications for customized experiences that leverage the unique capabilities of the mobile devices. For example, various locations (e.g., theme parks, conventions, tourist destinations, etc.) and services (e.g., airlines, public transportation, etc.) provide specialized mobile applications that can be downloaded and installed on a mobile device.

### SUMMARY

Aspects of the present invention disclose a method, computer program product, and system for managing applications on a computing device. The method includes one or more processors receiving a user utilizing a scheduling function of a computing device to schedule a time to uninstall an application from the computing device. The method further includes waiting until the scheduled time to uninstall the application. The method further includes, in response to determining that the scheduled time to uninstall the application has arrived, one or more processors uninstalling the application from the computing device. In another aspect of the present invention, the scheduling function of the computing device is a feature of operating system software of the computing device. In additional aspects of the present invention, the computing device is a mobile computing device, and the application is a mobile device application that is installed on the mobile device.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for managing the installation time and the uninstallation time for a user-selected application, in accordance with embodiments of the present invention.

FIG. 3 depicts a block diagram of components of a computing system representative of the client device and server of FIG. 1, in accordance with an embodiment of the present invention.

### DETAILED DESCRIPTION

Embodiments of the present invention allow for an expansion to the mobile application installation process. Upon selecting an application to install, the user is prompted to specify whether the software should be installed immediately or if the installation should be deferred to a later date. In addition, the user can select a date or duration of when the application is to be uninstalled. Then, on the selected dates the application will be installed and uninstalled.

Some embodiments of the present invention recognize that the usage patterns of how users utilize applications has changed. For desktop based applications, the application is installed on the user's computer and often remains on the computer for a significant amount of time along with local storage of application and user data. Web-based applications have reduced the need to install an application and have increased the capabilities to store the user and application data in remote storage (e.g., cloud storage). With mobile applications, a user installs applications onto a mobile device, while a large amount of the data can be persisted in the cloud. However, mobile devices can have more resource constraints in terms of storage space compared to desktop computers and laptop computers. Users are often installing new applications and must manage storage space along with the desire for certain applications.

Implementation of embodiments of the invention may take a variety of forms, and exemplary implementation details are discussed subsequently with reference to the Figures.

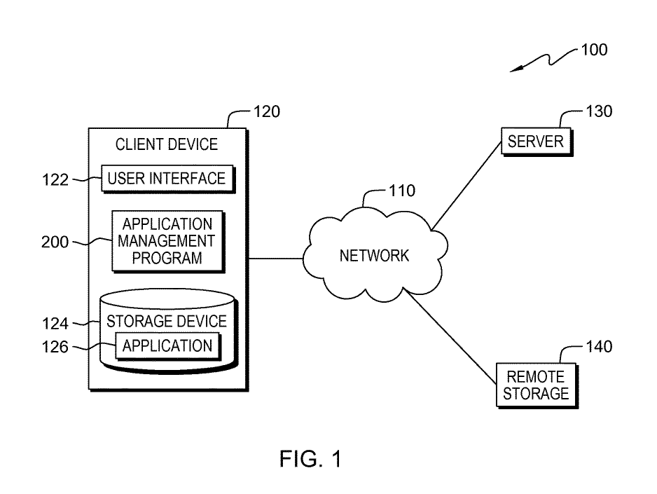

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes client device 120, server 130, and remote storage 140, all interconnected over network 110. In an example embodiment, client device 120 is a mobile device that downloads applications from server 130 and remotely stores data on remote storage 140, via network 110. In one embodiment, client device 120, server 130, and remote storage 140 communicate through network 110. Network 110 can be, for example, a local area network (LAN), a telecommunications network, a wide area network (WAN), such as the Internet, or any combination of the three, and include wired, wireless, or fiber optic connections. In general, network 110 can be any combination of connections and protocols that will support communications between client device 120, server 130, and remote storage 140, in accordance with embodiments of the present invention.

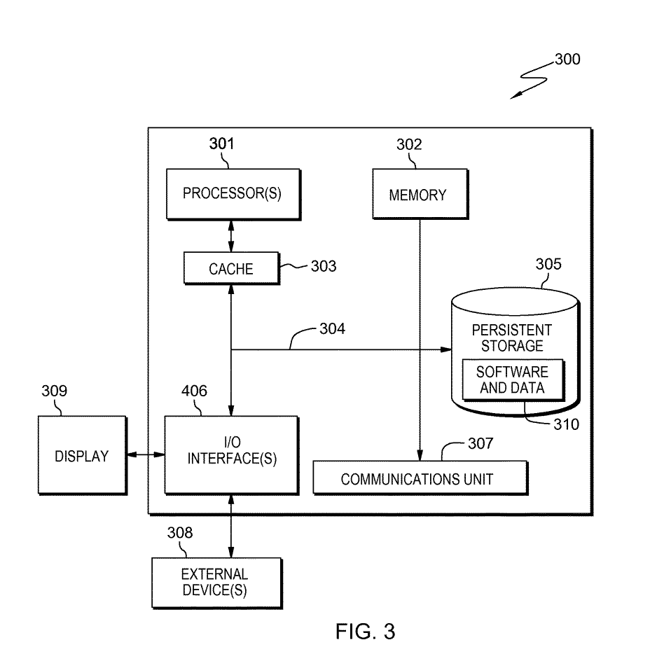

In various embodiments of the present invention, client device 120 may be a workstation, personal computer, personal digital assistant, mobile phone, or any other device capable of executing computer readable program instructions, in accordance with embodiments of the present invention. In general, client device 120 is representative of any electronic device or combination of electronic devices capable of executing computer readable program instructions. Client device 120 may include components, as depicted and described in further detail with respect to FIG. 3, in accordance with embodiments of the present invention.

Client device 120 includes user interface 122, storage device 124, and application management program 200. User interface 122 is a program that provides an interface between a user of client device 120 and a plurality of applications that reside on the client device. A user interface, such as user interface 122, refers to the information (such as graphic, text, and sound) that a program presents to a user, and the control sequences the user employs to control the program. A variety of types of user interfaces exist. In one embodiment, user interface 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 122 is a script or application programming interface (API). In an example embodiment, an individual utilizes user interface 122 to select a mobile application to download and install on client device 120.

Application management program 200 manages the installation time and the uninstallation time for a user selected application, in accordance with embodiments of the present invention. For example, an individual utilizing client device 120 selects an application (e.g., application 126) to install on client device 120 from server 130. Application management program 200 manages the installation and uninstallation times of the selected application for client device 120. In one embodiment, application management program 200 is a function of the operating system of client device 120 (e.g., a feature built in to the operating system of a mobile device). In another embodiment, application management program 200 is an application on client device 120 (i.e., an application other than the applications that application management program 200 manages). In additional embodiments, application management program 200 provides a scheduling function (e.g., of the operating system of client device 120 and/or a function installed on client device 120, such as an application programming interface (API), etc.) that allows a user to define one or more of an install time and a uninstall time for the application.

Storage device 124 includes application 126. Storage device 124 can be implemented with any type of storage device, for example, persistent storage 305, which is capable of storing data that may be accessed and utilized by client device 120, server 130, and remote storage 140, such as a database server, a hard disk drive, or a flash memory. In other embodiments, storage device 124 can represent multiple storage devices within client device 120. Storage device 124 stores information and data of client device 120, including application 126. Application 126 is a computer program that is capable of being installed on client device 120 and operating on client device 120. In one embodiment, application 126 is a mobile application that a user of client device 120 has installed onto client device 120. For example, the user of client device 120 downloads application 126 from server 130 and installs application 126 onto storage device 124 of client device 120. In another embodiment, application 126 is capable of storing data (e.g., application data, user data, etc.) remotely onto remote storage 140. In various embodiments, application 126 can be any type of mobile application software that client device 120 is capable of installing and utilizing.

In example embodiments, server 130 can be a desktop computer, a computer server, or any other computer systems known in the art. In certain embodiments, server 130 represents computer systems utilizing clustered computers and components (e.g., database server computers, application server computers, etc.) that act as a single pool of seamless resources when accessed by elements of data processing environment 100 (e.g., client device 120). In general, server 130 is representative of any electronic device or combination of electronic devices capable of executing computer readable program instructions. Server 130 may include components, as depicted and described in further detail with respect to FIG. 3, in accordance with embodiments of the present invention.

Server 130 is a component of an application distribution platform (e.g., server hosts an application distribution platform, or server 130 is one of a plurality of servers that host application distribution platform). In one embodiment, the application distribution platform is operated by the owner of the mobile operating system of client device 120. In another embodiment, the application distribution platform is operated by an entity that is capable of providing applications that can be installed and executed on client device 120. In an example embodiment, server 130 hosts application 126, which can be downloaded from server 130 via network 110 and installed onto client device 120. In various embodiments, server 130 can be any platform that is capable of providing applications (e.g., application 126) to client device 120 in response to a request from client device 120.

Remote storage 140 is a storage location that is accessible to client device 120 via network 110. Remote storage 140 can be implemented with any type of storage device, for example, persistent storage 305, which is capable of storing data that may be accessed and utilized by client device 120, server 130, and remote storage 140, such as a database server, a hard disk drive, or a flash memory. In other embodiments, remote storage 140 can represent multiple storage devices. In an example embodiment, remote storage 140 is a database server that client device 120 utilizes to store data. In one embodiment, client device 120 remotely stores data associated with application 126 (e.g., user data, application data, preferences, etc.) on remote storage 140. In various embodiments, since client device 120 stores data associated with application 126 on remote storage 140, client device 120 can uninstall application 126 and still retain access to the associated data because the associated data is persisted on remote storage 140. In one example, remote storage 140 is a storage location that is associated with a cloud-based service that client device 120 utilizes (e.g., a cloud-based storage location or multiple cloud-based storage locations).

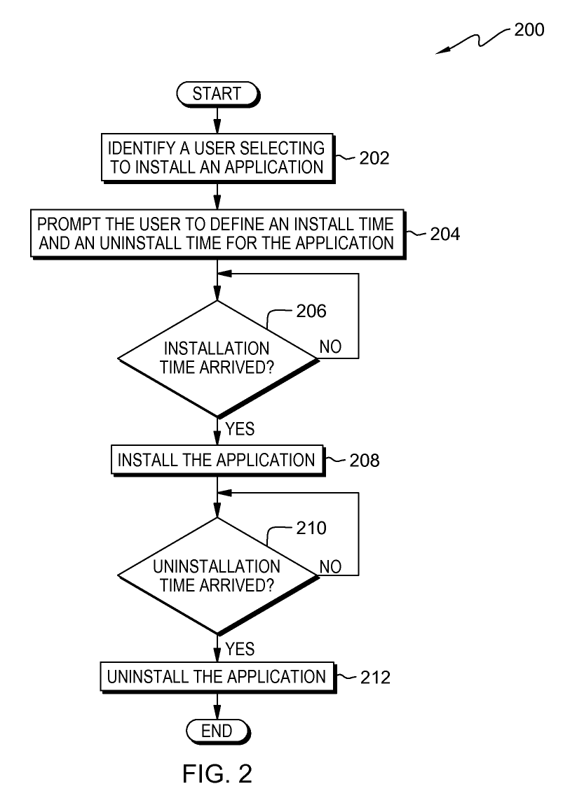

FIG. 2 is a flowchart depicting operational steps of application management program 200, a program for managing the installation time and the uninstallation time for a user selected application, in accordance with embodiments of the present invention.

In step 202, application management program 200 identifies a user selecting to install an application. In one embodiment, application management program 200 identifies a user of client device 120 selecting (e.g., via user interface 122) an application to install from server 130. For example, a user of client device 120 is planning a vacation to a popular theme park. The theme park provides a mobile application (e.g., application 126) that is available for download from server 130. The mobile application is specific to the theme park (e.g., provides navigation information, information on acquiring places in line, etc.). Application management program 200 identifies that the user of client device 120 utilizes user interface 122 to select the mobile application to download from server 130 an install on client device 120.

In step 204, application management program 200 prompts the user to define an install time and an uninstall time for the application. In one embodiment, application management program 200 prompts the user of client device 120 to define one or more of an install time and an uninstall time for the application (selected in step 202). For example, application management program 200 prompts the user to utilize a scheduling function to define one or more of an install time and an uninstall time for the application. In various embodiments, application management program 200 allows a user to define a time in the format of a specified day, a specified time, a specified time and day, a specified time duration, or other forms of constraints. Application management program 200 can store the received definition on client device 120 (e.g., on storage device 124 associated with application 126).

In one scenario, application management program 200 prompts the user of client device 120, and the user defines an installation time of “Jun. 1, 2015” and an uninstallation time of “Jun. 9, 2015.” In another scenario, application management program 200 prompts the user of client device 120, and the user defines an installation time of “2:00 AM on Jun. 1, 2015” and an uninstallation time of “Jun. 9, 2015.” In an additional scenario, application management program 200 prompts the user of client device 120, and the user defines an installation time of “2:00 AM on Jun. 1, 2015,” an uninstallation time of “Jun. 9, 2015,” and the user of client device 120 indicates to download and install the application when client device 120 is connected to a preferred wireless network (e.g., the “home” network of the user, etc.). In yet another scenario, application management program 200 prompts the user of client device 120 and the user defines an installation time of “2:00 AM on Jun. 1, 2015” and an uninstallation time of “two weeks after installation.”

In one example, the user of client device 120 selects to download the mobile application for the theme park from server 120 (in step 202). In response to identifying the selection, application management program 200 prompts the user to define an install time and/or an uninstall time for the mobile application. The user of client device 120 is planning a vacation to the theme park and provides a response to application management program 200 (utilizing user interface 122) that defines an installation time of over a month in the future but a few days before the user is departing on the vacation (e.g., Jun. 30, 2015, 2:00 AM on Jun. 30, 2015, etc.). In addition, the user of client device 120 defines that application management program 200 is to download the mobile application from server 130 when client device 120 is connected to the “home” wireless network of client device 120 (e.g., as to not utilize additional mobile communication data). Further, since the user of client device 120 only visits the theme park about once every few years, the user selects an uninstall time for the application to be a few days after the user returns from the vacation (e.g., the user sets an “expiration time” of Jul. 7, 2015, 3:00 AM on Jul. 7, 2015, etc.).

In another example, application management program 200 prompts the user of client device 120 to provide an indication of whether to install the selected application now or to defer installation to a later date and/or time. In addition, the user of client device 120 can provide a response indicating to not uninstall the application (e.g., an indefinite uninstall time). In an additional embodiment, a user of client device 120 selects an application (an alternate instance of step 202) that is already installed on client device 120 (e.g., application 126) and indicates to application management program 200 to define an uninstall time. In this embodiment, the selected application has an indefinite uninstall time (e.g., no uninstall time) or an uninstall time that has not come yet. The user of client device 120 can utilize application management program 200 to define (or redefine) an uninstall time for the selected application (e.g., from an indefinite time to a defined time).

In decision step 206, application management program 200 determines whether the installation time has arrived. In one embodiment, application management program 200 compares the current time for client device 120 to the defined install time for the application (defined in step 204) to determine whether the installation time has arrived. In one example, the user of client device 120 defined to install the application now (i.e., to install when the user selects the application). In this example, application management program 200 determines that the installation time has arrived.

In another example, the user of client device 120 defined to install the application at 2:00 AM on Jun. 1, 2015 (defined in step 204). In this example, if application management program 200 determines that the time that client device 120 utilizes indicates that 2:00 AM on Jun. 1, 2015 has arrived (i.e., the current time is 2:00 AM on Jun. 1, 2015, or that the current time is after 2:00 AM on Jun. 1, 2015, etc.), then application management program 200 determines that the installation time has arrived.

In an additional example, the user of client device 120 defined to install the application at 2:00 AM on Jun. 1, 2015 and to download the application utilizing the “home” wireless network of client device 120 (defined in step 204). In this example, if application management program 200 determines that the time that client device 120 utilizes indicates that 2:00 AM on Jun. 1, 2015 has arrived and that client device is connected to the “home” network, then application management program 200 determines that the installation time has arrived.

In response to determining that the installation time has arrived (decision step 206, yes branch), application management program 200 installs the application (step 208). In response to determining that the installation time has not arrived (decision step 206, no branch), application management program 200 continues waiting until the installation time arrives. In various embodiments, the “no” branch loop for decision step 206 allows application management program 200 to wait until the defined installation time arrives. In an example embodiment, application management program 200 can terminate (e.g., go into a sleep mode) and reinitiate at the defined installation time.

In step 208, application management program 200 installs the application. More specifically, in response to determining that the defined installation time has arrived (decision step 206, yes branch), application management program 200 installs the selected application. For example, application management program 200 downloads application 126 from server 130 and installs application 126 on client device 120 (e.g., in storage device 124). In various embodiments, while application 126 is installed on client device 120, application 126 and/or client device 120 can persist data associated with application 126 (e.g., user data, preferences, application specific data, etc.) to remote storage 140. In the previously discussed examples, application management program 200 downloads and installs the application for the theme park (e.g., application 126) prior to the user of client device 120 leaving for vacation (i.e., at the defined installation time).

In decision step 210, application management program 200 determines whether the uninstallation time has arrived. In one embodiment, application management program 200 compares the current time for client device 120 to the defined uninstall time for the application (defined in step 204) to determine whether the installation time has arrived. In one scenario, the user of client device 120 defined to uninstall the application at 3:00 AM on Jul. 7, 2015 (defined in step 204). In this scenario, if application management program 200 determines that the time that client device 120 utilizes indicates that 3:00 AM on Jul. 7, 2015 has arrived (i.e., the current time is 3:00 AM on Jul. 7, 2015, or that the current time is after 3:00 AM on Jul. 7, 2015, etc.), then application management program 200 determines that the uninstallation time has arrived.

In response to determining that the uninstallation time has arrived (decision step 210, yes branch), application management program 200 uninstalls the application (step 212). In response to determining that the uninstallation time has not arrived (decision step 210, no branch), application management program 200 continues waiting until the uninstallation time arrives. In various embodiments, the “no” branch loop for decision step 210 allows application management program 200 to wait until the defined uninstallation time arrives. In an example embodiment, application management program 200 can terminate (e.g., go into a sleep mode) and reinitiate at the defined uninstallation time.

In step 212, application management program 200 uninstalls the application. More specifically, in response to determining that the uninstallation time has arrived (decision step 210, yes branch), application management program 200 uninstalls the selected application (e.g., application 126) from client device 120 (step 212). In one scenario, application management program 200 is a function of the operating system of client device 120, which uninstalls application 126. In another scenario, application management program 200 utilizes the operating system of client device 120 to uninstall application 126 (e.g., application management program 200 performs an action that initiates the uninstallation). In various embodiments, since client device 120 and/or application 126 can persist data associated with application 126 to remote storage 140, application management program 200 can uninstall application 126 and client device 120 will still be able to have access to the associated data because remote storage 140 can continue to store the associated data.

In the previously discussed examples, application management program 200 uninstalls the application for the theme park from client device 120 (e.g., application 126) after the user has returned from vacation (i.e., at the defined uninstallation time). Uninstalling the application for the theme park reduces the amount of unnecessary data stored on client device 120, which frees up storage space (e.g., on a mobile device with a limited amount of data storage capacity). However, since the application has persisted associated data (e.g., user data, preferences, application specific data, etc.) to remote storage 140 (e.g., a cloud-based data storage service), the user of client device 120 can maintain access to the associated data for future use (e.g., a subsequent installation of the application and a future vacation to the theme park).

FIG. 3 depicts computer system 300, which is representative of client device 120 and server 130, in accordance with an illustrative embodiment of the present invention. It should be appreciated that FIG. 3 provides only an illustration of one implementation and does not imply any limitations with regard to the environments in which different embodiments may be implemented. Computer system 300 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processor(s) 301 by holding recently accessed data, and data near recently accessed data, from memory 302.

Program instructions and data (e.g., software and data 310) used to practice embodiments of the present invention may be stored in persistent storage 305 and in memory 302 for execution by one or more of the respective processor(s) 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 310 can be stored in persistent storage 305 for access and/or execution by one or more of the respective processor(s) 301 via cache 303. With respect to client device 120, software and data 310 includes application management program 200 and application 126.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data (e.g., software and data 310) used to practice embodiments of the present invention may be downloaded to persistent storage 305 through communications unit 307.

I/O interface(s) 306 allows for input and output of data with other devices that may be connected to each computer system. For example, I/O interface(s) 306 may provide a connection to external device(s) 308, such as a keyboard, a keypad, a touch screen, and/or some other suitable input device. External device(s) 308 can also include portable computer readable storage media, such as, for example, thumb drives, portable optical or magnetic disks, and memory cards. Program instructions and data (e.g., software and data 310) used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method for managing applications on a computing device, the method comprising:
identifying, by one or more processors, a user selecting an application to install on a computing device;
providing, by one or more processors, a prompt to the user to utilize a scheduling function of the computing device to define (i) a time to download and install the application on to the computing device and (ii) a time to uninstall the application from the computing device;
waiting until the scheduled time to download and install the application;
in response to determining that the scheduled time to download and install the application has arrived, downloading and installing, by one or more processors, the application to the computing device;
waiting until the scheduled time to uninstall the application; and
in response to determining that the scheduled time to uninstall the application has arrived, uninstalling, by one or more computer processors, the application from the computing device.

2. The method of claim 1, wherein the scheduling function of the computing device is a feature of operating system software of the computing device.

3. The method of claim 1:
wherein the computing device is a mobile computing device; and
wherein the application is a mobile device application that is installed on the mobile device.

4. (canceled)

5. (canceled)

6. The method of claim 1, wherein downloading and installing the application to the computing device further comprises:
providing, by one or more processors, a prompt to the user to utilize a scheduling function of the computing device to define a preferred wireless network to utilize to install the application;
waiting until the scheduled time to download and install the application and until the computing device is utilizing the preferred wireless network;
in response to determining that the scheduled time to download and install the application has arrived and that the computing device is utilizing the preferred wireless network, downloading, by one or more processors, the application to the computing device utilizing the preferred wireless network; and
installing, by one or more processors, the application to the computing device.

7. The method of claim 1, wherein the scheduled time to uninstall the application is one of:
a date on which to uninstall the application;
a time of day at which to uninstall the application; and
a time duration after which to uninstall the application.

8. A computer program product for managing applications on a computing device, the computer program product comprising:
one or more computer readable storage media and program instructions stored on the one or more computer readable storage media, the program instructions comprising:
program instructions to identify a user selecting an application to install on a computing device;
program instructions to provide a prompt to the user to utilize a scheduling function of the computing device to define (i) a time to download and install the application on to the computing device and (ii) a time to uninstall the application from the computing device;
program instructions to wait until the scheduled time to download and install the application;
in response to determining that the scheduled time to download and install the application has arrived, program instructions to download and install the application to the computing device;
program instructions to wait until the scheduled time to uninstall the application; and
in response to determining that the scheduled time to uninstall the application has arrived, uninstalling, by one or more computer processors, the application from the computing device.

9. The computer program product of claim 8, wherein the scheduling function of the computing device is a feature of operating system software of the computing device.

10. The computer program product of claim 8:
wherein the computing device is a mobile computing device; and
wherein the application is a mobile device application that is installed on the mobile device.

11. (canceled)

12. (canceled)

13. The computer program product of claim 8, wherein the program instructions to download and install the application to the computing device further comprise program instructions, stored on the one or more computer readable storage media, to:
provide a prompt to the user to utilize a scheduling function of the computing device to define a preferred wireless network to utilize to install the application;
wait until the scheduled time to download and install the application and until the computing device is utilizing the preferred wireless network;
in response to determining that the scheduled time to download and install the application has arrived and that the computing device is utilizing the preferred wireless network, download the application to the computing device utilizing the preferred wireless network; and
install the application to the computing device.

14. The computer program product of claim 8, wherein the scheduled time to uninstall the application is one of:
a date on which to uninstall the application;
a time of day at which to uninstall the application; and
a time duration after which to uninstall the application.

15. A computer system for managing applications on a computing device, the computer system comprising:
one or more computer processors;
one or more computer readable storage media; and
program instructions stored on the computer readable storage media for execution by at least one of the one or more processors, the program instructions comprising:
program instructions to identify a user selecting an application to install on a computing device;
program instructions to provide a prompt to the user to utilize a scheduling function of the computing device to define (i) a time to download and install the application on to the computing device and (ii) a time to uninstall the application from the computing device;
program instructions to wait until the scheduled time to download and install the application;
in response to determining that the scheduled time to download and install the application has arrived, program instructions to download and install the application to the computing device;
program instructions to wait until the scheduled time to uninstall the application; and
in response to determining that the scheduled time to uninstall the application has arrived, uninstalling, by one or more computer processors, the application from the computing device.

16. The computer system of claim 15, wherein the scheduling function of the computing device is a feature of operating system software of the computing device.

17. The computer system of claim 15:
wherein the computing device is a mobile computing device; and
wherein the application is a mobile device application that is installed on the mobile device.

18. (canceled)

19. (canceled)

20. The computer system of claim 8, wherein the program instructions to download and install the application to the computing device further comprise program instructions, stored on the computer readable storage media for execution by at least one of the one or more processors, to:
provide a prompt to the user to utilize a scheduling function of the computing device to define a preferred wireless network to utilize to install the application;
wait until the scheduled time to download and install the application and until the computing device is utilizing the preferred wireless network;
in response to determining that the scheduled time to download and install the application has arrived and that the computing device is utilizing the preferred wireless network, download the application to the computing device utilizing the preferred wireless network; and
install the application to the computing device.

21. The method of claim 1, further comprising:
prior to uninstalling the application from the computing device, storing, by one or more processors, data, from the computing device, that is associated with the application on a remote storage location.

22. The method of claim 21, further comprising:
in response to receiving a request to re-install the application on to the computing device, accessing, by one or more processors, the stored data on the remote storage location.

23. The computer program product of claim 8, further comprising program instructions, stored on the one or more computer readable storage media, to:
prior to uninstalling the application from the computing device, store data, from the computing device, that is associated with the application on a remote storage location.

24. The computer program product of claim 8, further comprising program instructions, stored on the one or more computer readable storage media, to:
in response to receiving a request to re-install the application on to the computing device, access the stored data on the remote storage location.

25. The computer system of claim 8, further comprising program instructions, stored on the computer readable storage media for execution by at least one of the one or more processors, to:
prior to uninstalling the application from the computing device, store data, from the computing device, that is associated with the application on a remote storage location.

26. The computer system of claim 8, further comprising program instructions, stored on the computer readable storage media for execution by at least one of the one or more processors, to:
in response to receiving a request to re-install the application on to the computing device, access the stored data on the remote storage location.
